(19) United States
(12) Patent Application Publication
(10) Pub. No.: US 2026/0284998 A1
(43) Pub. Date: Sep. 24, 2026

(54) METHOD FOR PRODUCING OBJECTS

(71) Applicant: SACMI COOPERATIVA MECCANICI IMOLA SOCIETA' COOPERATIVA, IMOLA (BOLOGNA) (IT)

(72) Inventors: FABRIZIO PUCCI, IMOLA (BOLOGNA) (IT); FIORENZO PARRINELLO, IMOLA (BOLOGNA) (IT); GIOVANNI MAZZOTTI, IMOLA (BOLOGNA) (IT); ELEONORA BALDUCCI, IMOLA (BOLOGNA) (IT); DAVIDE ZANOTTI, IMOLA (BOLOGNA) (IT); FRANCESCO PIRAZZOLI, IMOLA (BOLOGNA) (IT)

(21) Appl. No.: 19/480,116

(22) PCT Filed: May 3, 2024
(86) PCT No.: PCT/IB2024/054299

§ 371 Date: Oct. 30, 2025

(30) Foreign Application Priority Data
May 5, 2023 (IT) 102023000008934

(51) Int. Cl. B31B 50/59; B31B 50/81; B31B 105/00; B31B 110/10

(52) U.S. Cl. CPC B31B 50/592; B31B 50/814; B31B 2105/00; B31B 2110/10

(57) ABSTRACT

An object is formed by joining a first component and a second component which are made with respective materials both containing fibres. At least one component selected from either the first component or the second component is subjected to moulding. The first component and the second component are joined during a pressing step in which a joining portion of the first component is pressed into contact with the second component, the joining portion being delimited by an anchoring surface intended to be joined to the second component. Before the pressing step, on the anchoring surface fibres are partially free, in order to promote joining of the first component and the second component. At least the joining portion or the entire portion of the first component may be subjected to moulding during the pressing step.

The invention relates to a method for producing objects by joining at least two components by pressing. The components which are joined in order to obtain the object comprise materials containing fibres, including natural fibres, for example cellulose fibres.

The objects which are produced by the apparatus according to the invention may be objects used in the packaging sector and may comprise for example containers, such as bottles, or caps for containers. However, it is also possible to use the method according to the invention to produce objects intended for technical sectors different from packaging.

In the packaging sector, as in many other technical sectors, it is desirable to gradually reduce the use of synthetic polymeric materials, mainly for environmental protection reasons. For this reason, it is desirable to use natural fibre-based materials, for example cellulose-based materials, to at least partially replace the synthetic polymeric materials.

However, whilst synthetic polymeric materials can easily be shaped into even complex geometries, for example by injection moulding or compression moulding, it is more difficult to form three-dimensional objects, above all if they have complex shapes, with natural fibre-based materials.

An object of the invention is to improve the methods for producing objects with a natural fibre-based material.

Another object is to provide a method for forming objects with a natural fibre-based material, which allows objects to be obtained which even have a relatively complex shape.

Another object is to provide a method for forming objects with a natural fibre-based material, in which the objects have good mechanical strength. A further object is to provide a method for forming objects with a natural fibre-based material, in which excessively complex moulds are not used.

In a first aspect of the invention, there is provided a method for forming an object by joining a first component and a second component which are made with respective materials both containing fibres which include natural fibres, wherein at least one component selected from either the first component or the second component is subjected to moulding, and wherein the first component and the second component are joined during a pressing step in which a joining portion of the first component is pressed into contact with the second component, the joining portion being delimited by an anchoring surface intended to be joined to the second component, and wherein, before the pressing step, on the anchoring surface fibres are present that are at least partially free, in order to promote joining of the first component and the second component.

When the anchoring surface of the first component, on which the free fibres are present, is pressed against the second component, the free fibres of the first component interact relatively easily with the second component, so as to render joining of the two components easier and more reliable. That is made possible because the free fibres are not rigidly incorporated in the structure of the component to which they belong. Consequently, the free fibres successfully bind to the adjacent component when pressure is applied, helping to create a strong joint.

Moreover, forming the object by joining two separate components makes it possible to produce even objects which have a complex shape. In fact, the two starting components have geometries which are simpler than that of the finished object, which makes it possible to use materials containing natural fibres, for example cellulose-based materials, which are more difficult to form than synthetic polymeric materials.

Moreover, it is possible to use moulds and tools which are less complex than those which would be necessary for producing the object in one piece. For example, by forming the object starting with two separate components, any undercuts can be limited or reduced.

The first component and the second component can be joined to each other, not just owing to the pressure applied during the pressing step, but also by applying heat and in appropriate moisture conditions (achievable for example by moistening the first component and/or the second component, if necessary). In some cases, it is also possible to use non-sticky additives which promote adherence of the first component to the second component.

During the pressing step, a pressure can be applied directly on the first component, or on the second component which transmits the pressure to the first component.

In one embodiment, the component subjected to moulding can be a pre-moulded component which was at least partially formed by a moulding process before being joined to the other component.

In this case, the component subjected to the moulding process is provided after it has been moulded, already ready to be joined to the other component.

In other words, the component was subjected to the moulding process before the pressing step.

In one embodiment, the component which is subjected to the moulding process can be moulded, entirely or partially, in contact with the other component.

In this case, the component subjected to the moulding process is subjected to moulding simultaneously with the pressing step which affects the joining portion.

In one embodiment, the joining portion has an initial density which is increased during the pressing step.

In this case, the free fibres are present because the joining portion does not have a compact structure like that which will be obtained at the end of the pressing step, instead having a relatively low initial density linked to the poor compaction of the fibres of which it is formed. In the joining portion it is possible to identify many empty spaces, surrounded by fibres which are free, at least for a portion of their length.

For example, the density of the joining portion could be at least doubled compared to the initial value, during the moulding in contact with the other component.

In one embodiment, the anchoring surface delimits a dose of natural fibre-based material having a substantially flat shape. The dose may also have a shape that is not flat, for example a concave shape or having zones with localised compression.

In this case, the pressing step affects not just the joining portion, but involves the entire dose, which during the pressing step is moulded in order to form the corresponding component of the object. In this way, the dose is overmoulded in contact with the other component. In this way, in the pressing step, it is possible both to mould the dose in order to obtain the corresponding moulded component of the object, and to join that component to the other component in order to form the desired object.

In one embodiment, the first component (which comprises the joining portion), before the pressing step, has zones having densities which are different from each other.

In particular, the density is lower in the joining portion and higher outside the joining portion.

When the first component having zones with densities which are different from each other is pressed in contact with the second component, the density of the joining portion increases and consequently the shape of the joining portion is changed. That is to say, a sort of localised overmoulding occurs, as a result of which the joining portion is formed in its definitive shape and simultaneously rendered fixed relative to the other component. In contrast, there are no changes in shape and density outside of the joining portion of the pressed component.

In one embodiment, the fibres which are at least partially free derive from a scratching treatment on the anchoring surface.

The scratching treatment allows removal of any covering surface layers initially present on the anchoring surface and at least partial separation of some fibres from the adjacent fibres, in a surface layer of the component on which the surface treatment is applied. In this way, the fibres which are at least partially free are generated which make joining the two components easier.

In one embodiment, the two components which are joined comprise respectively a container neck and a container body.

In this way, it is possible to produce containers, for example bottles, starting with two components having a relatively simple shape.

The joining portion may comprise a peripheral flange of the container neck and/or of the container body.

In one embodiment, the two components which are joined comprise respectively a container neck and a sheet material.

The container neck may be joined to the sheet material whilst the latter is flat.

The sheet material may be unwound from a reel or in the form of pre-cut sheets. In the latter case, each pre-cut sheet may have dimensions such that a single container will be obtained from the pre-cut sheet.

The sheet material will then be folded, welded and -if necessary-cut in order to obtain the container, already provided with the relative neck.

The sheet material may be single-layer, for example made with a cellulose material to which additives may be added.

Alternatively, the sheet material may have a multi-layer structure.

The sheet material may even be laminated.

In one embodiment, the two components which are joined are two parts of a closure for a container, intended to be joined at a hinge.

In this way, it is possible to obtain closures for containers of the so-called “snap” or “hinged” type, in which one part of the closure is intended to be connected to a container neck, whilst the other part of the closure is movable between an open position and a closed position by rotating around a hinge which joins the two parts of the closure.

In a second aspect of the invention, there is provided a method comprising the steps of:
providing a sheet material;
applying a container dispensing part on the sheet material;
folding and welding the sheet material to obtain a container, wherein the container dispensing part is made with a natural fibre-based material, which comprises at least 80% cellulose by weight.

Owing to this aspect of the invention, it is possible to obtain a container having a low environmental impact. In fact, the sheet material may be a material of the type currently used for producing aseptic containers, which comprises a large quantity of cellulose material and which can be recycled. The container dispensing part made with a natural fibre-based material allows replacement of the current dispensing parts made of synthetic plastic material, with a dispensing part consisting mostly of cellulose, which—after use—can easily be recycled or disposed of, reducing the pollution caused by the current dispensing parts made of synthetic plastic material.

The invention can be better understood and implemented with reference to the accompanying drawings, which illustrate several example, non-limiting embodiments of it, in which:

FIG. 1 is a schematic cross-section showing a bottle made with a natural fibre-based material;

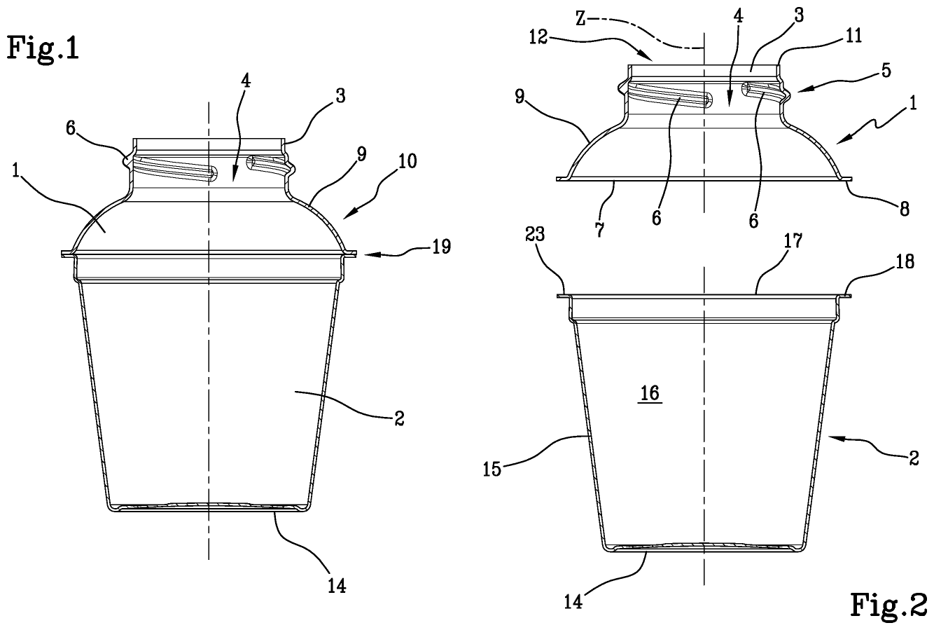

FIG. 2 is a schematic cross-section, showing the two components which form the bottle of FIG. 1;

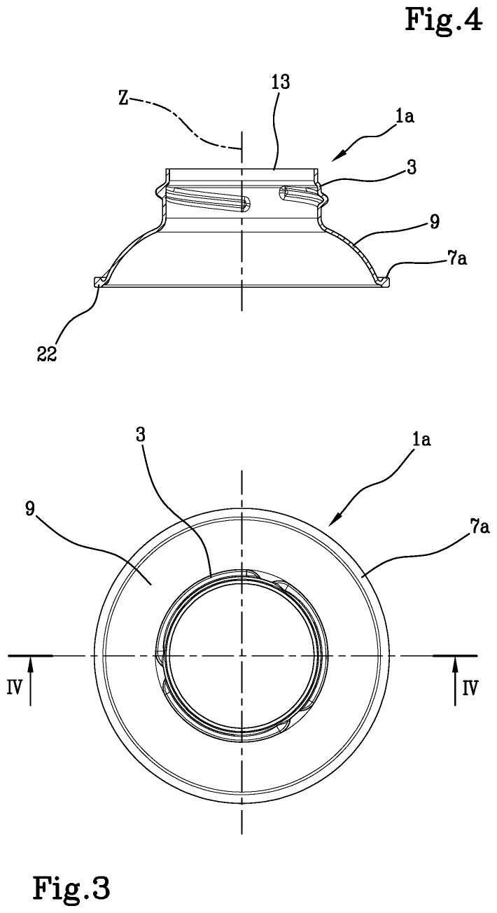

FIG. 3 is a top view of a container dispensing part, usable for example for producing the bottle of FIG. 1;

FIG. 4 is a cross-section taken along the plane IV-IV of FIG. 3;

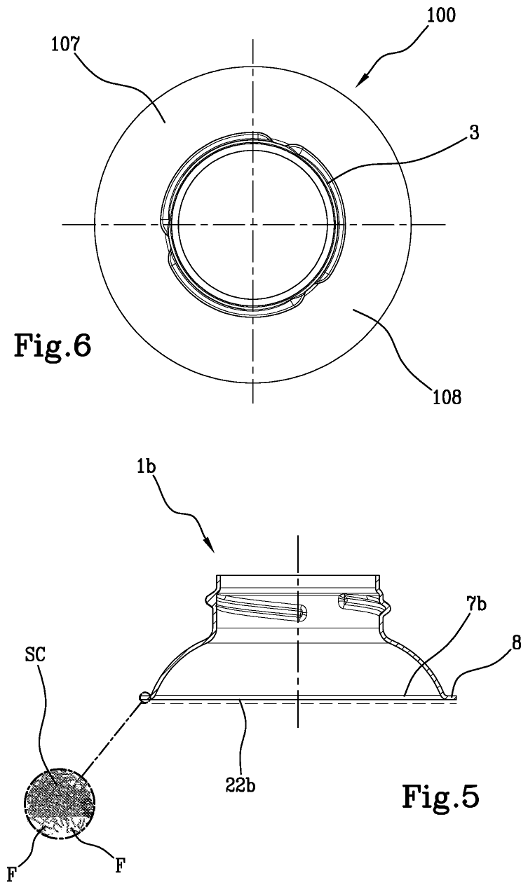

FIG. 5 is a cross-section like that of FIG. 4, schematically showing a container dispensing part according to an alternative embodiment;

FIG. 6 is a view like that of FIG. 3, showing a container dispensing part according to another alternative embodiment;

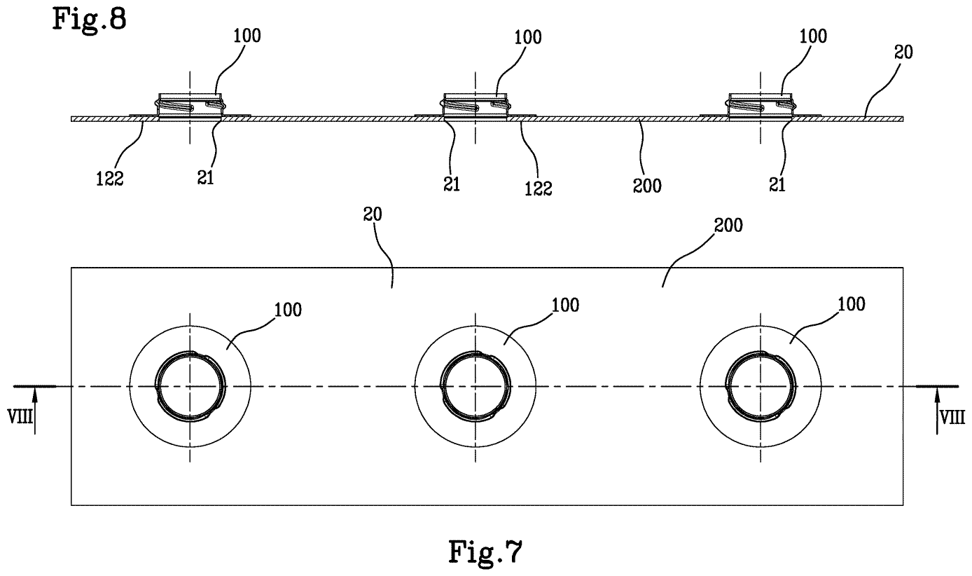

FIG. 7 is a schematic top view, showing a sheet material on which a plurality of container dispensing parts of the type shown in FIG. 6 have been attached;

FIG. 8 is a cross-section taken along the plane VIII-VIII of FIG. 7;

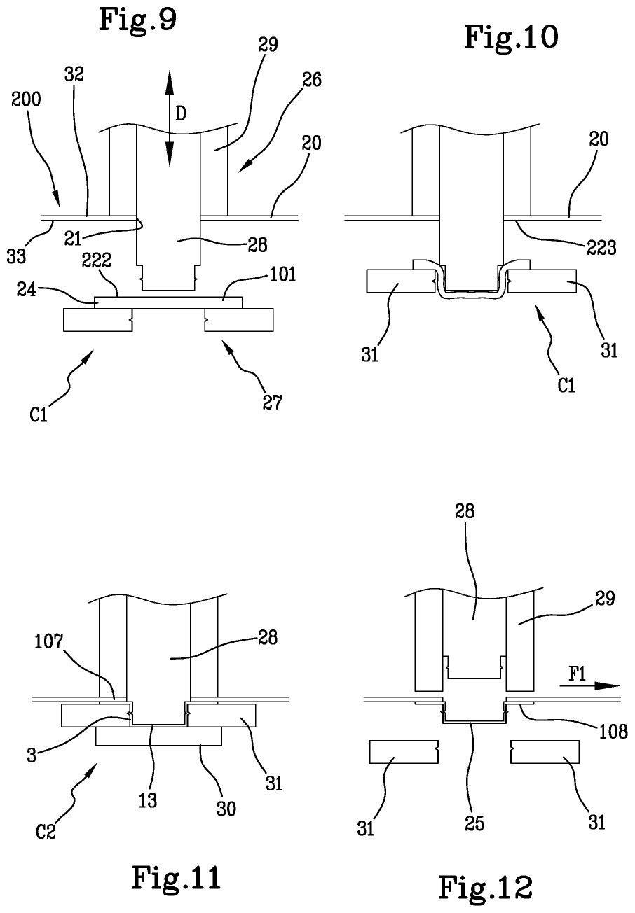

FIGS. 9 to 12 are cross-sections schematically showing the steps of a method for moulding a container dispensing part on a sheet material;

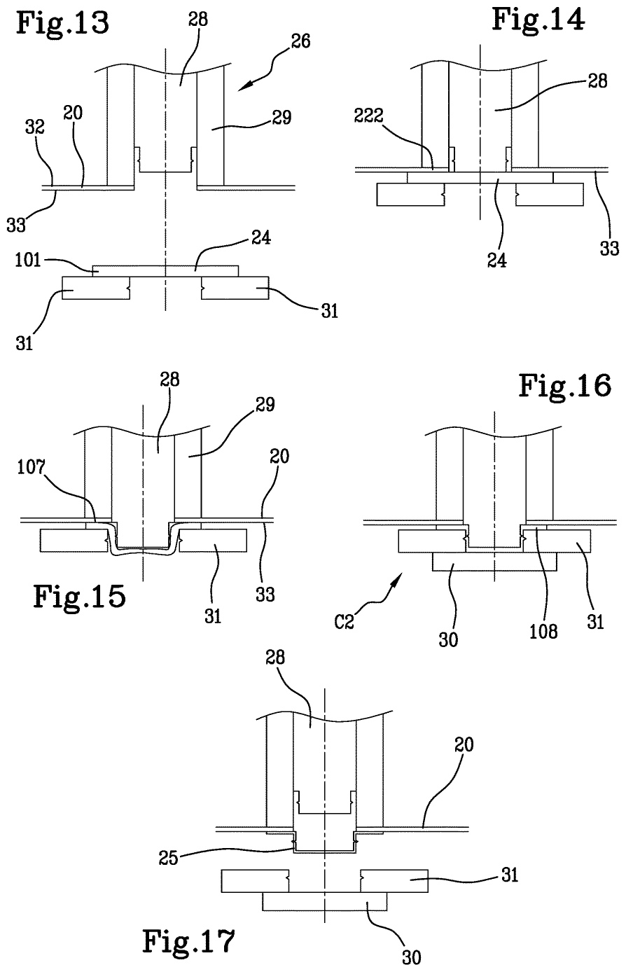

FIGS. 13 to 17 are cross-sections schematically showing the steps of a method for moulding a container dispensing part on a sheet material, according to an alternative embodiment;

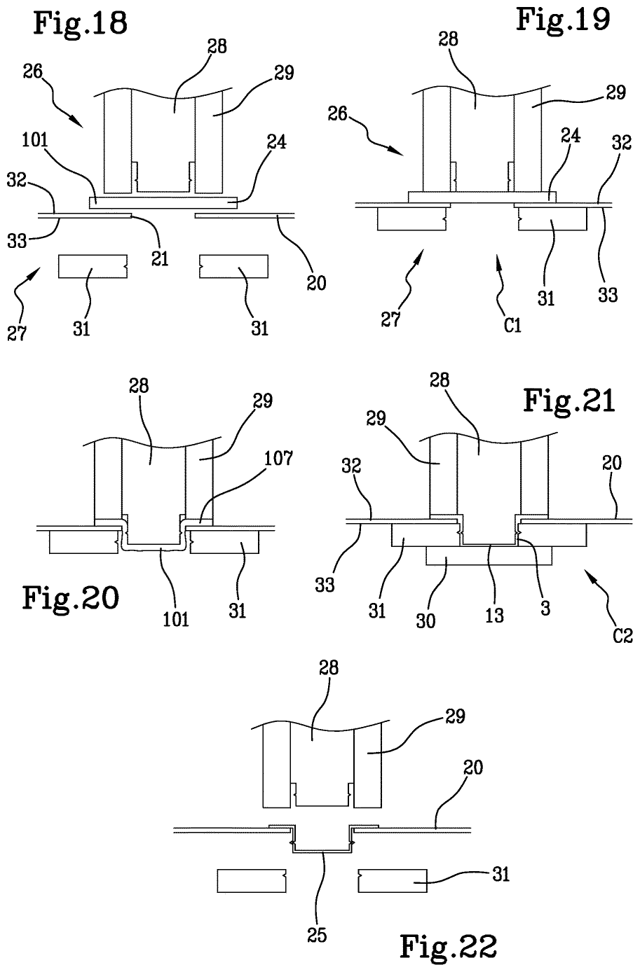

FIGS. 18 to 22 are cross-sections schematically showing the steps of a method for moulding a container dispensing part on a sheet material, according to a further alternative embodiment;

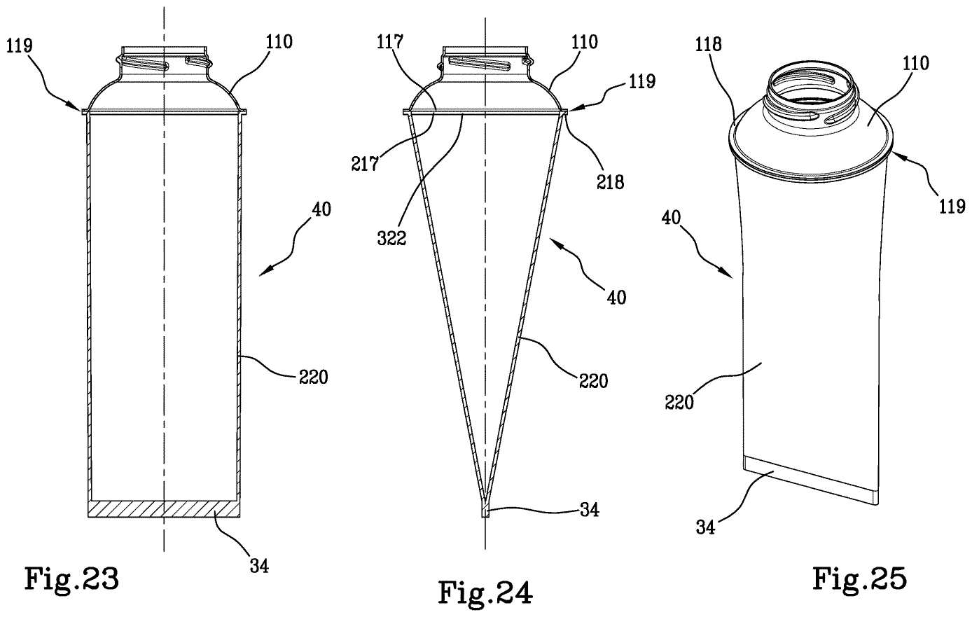

FIG. 23 is a cross-section showing a squeezable container;

FIG. 24 is a cross-section of the squeezable container of FIG. 23, taken in a cross-section plane perpendicular to that of FIG. 23;

FIG. 25 is a perspective view of the squeezable container shown in FIGS. 23 and 24;

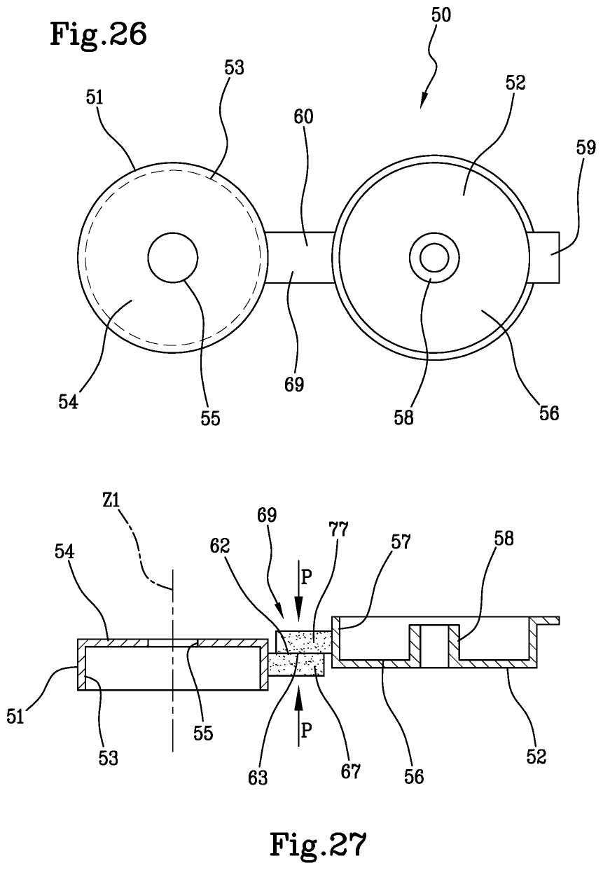

FIG. 26 is a schematic plan view showing a closure for a container, in an open configuration;

FIG. 27 is a schematic side view showing a step of a method for producing the closure of FIG. 26.

FIG. 1 shows a container 10 for containing a fluid substance, in particular shaped like a bottle.

The container 10 is made by joining two components, that is to say, a first component 1 and a second component 2, which are shown in a disassembled configuration in FIG. 2.

The first component 1 and the second component 2 are made with respective materials both containing natural fibres. The first component 1 and the second component 2 may optionally be made with the same material.

In particular, the first component 1 and the second component 2 may be made with cellulose-based materials. In particular, the first component 1 and the second component 2 may be made with a material containing at least 80% cellulose by weight.

In addition to the natural fibres, in particular cellulose fibres, the first component 1 and/or the second component 2 may comprise synthetic polymeric fibres, in a quantity significantly lower than the quantity of natural fibres. For example, the material with which the first component 1 and/or the second component 2 are made may comprise a quantity of synthetic polymeric fibres less than or equal to 10% by weight.

In the example shown, the first component 1 is shaped like a container dispensing part, whilst the second component 2 is shaped like a container body.

The first component 1 may comprise a neck 3, which surrounds a dispensing passage 4 through which a consumer can access a substance contained in the container 10, for example by drinking the substance directly from the neck 3 or by pouring the substance from the container 10. The neck 3 extends around an axis Z and may have a substantially cylindrical shape.

The neck 3 has a fixing structure 5 by means of which a cap not shown can be removably fixed to the neck 3 to open or selectively to close the container 10. The fixing structure 5 may comprise one or more helical threads 6 by means of which the cap can be screwed onto the neck 3. Alternatively, the fixing structure may comprise fixing elements of a type different from threads, for example one or more projections, or recesses, or cam elements or bayonet connectors.

The first component 1 further comprises a first joining portion 7 along which the first component 1 is intended to be joined to the second component 2. The first joining portion 7 may comprise a flange 8. The latter may be substantially flat, or may have a geometry that is not flat, for example undulating, curved, or with one or more grooves. The flange 8 may have a shape which in plan view is like an annulus, or a different shape, depending on the geometry of the container 10.

The first component 1 may also comprise an intermediate portion 9 interposed between the neck 3 and the flange 8. The intermediate portion 9 connects the neck 3 to the flange 8. The intermediate portion 9 has a transversal dimension, measured perpendicularly to the axis Z, which gradually decreases from the flange 8 to the neck 3. In the example shown, the intermediate portion 9 is dome-shaped, and has a concave geometry with the concavity directed towards the inside of the container 10. However, other geometries are possible for the intermediate portion 9, for example a frustoconical geometry.

The first component 1 is a moulded component. For example, the first component 1 may be formed by means of a substantially dry forming process, which uses a cellulose-based starting material containing a quantity of water not greater than 20% by weight. The starting material may be in the form of powder. Alternatively, the starting material may be a fluffy element, for example a wad of fluff or a dose of airlaid.

A dose of airlaid can be obtained by cutting an airlaid material in sheet form, for example unwound from a reel. The airlaid material may be obtained starting from a compact web of cellulose-based material, which has a relatively high density and which can be unwound from a reel. The compact web is ground and defibrized, then the fibres are recombined to form a sheet of material with low density, in which significant quantities of air are present between one fibre and another. An airlaid material is obtained in this way. It is possible to add to the airlaid material small quantities of additives in the liquid state, for example water, to promote the subsequent moulding process.

The first component 1 is a one-piece component.

The neck 3 may be open, as in the example shown in FIGS. 1 and 2. In this case, the neck 3 is delimited by a free edge 11 positioned at the opposite end of the neck 3 to the flange 8. The free edge 11 surrounds an opening 12 by means of which it is possible to access the inside of the container 10.

In an alternative embodiment, the neck 3 may be closed, as shown in FIG. 4. In this case, the neck 3 comprises a membrane 13 which closes the dispensing passage 4. The membrane 13 is produced when the first component 1 is moulded and can be removed or pierced before filling the container 10 with a desired substance. Alternatively, the membrane 13 may be removed or pierced by the consumer when the container 10 is opened for the first time.

Even if FIG. 4 relates to an alternative embodiment of a first component, it shall be understood that the membrane 13 shown in FIG. 4 may also be provided in the first component 1 shown in FIGS. 1 and 2.

The second component 2 comprises a base wall 14 which, in use, is suitable for being rested on a supporting surface. The base wall 14 may be substantially flat, or slightly inwardly rounded, or may have other shapes. The base wall 14 is arranged transversally to the axis Z, after the first component 1 and the second component 2 have been joined to form the container 10.

The second component 2 further comprises a lateral wall 15, which projects from the base wall 14 and extends around the axis Z. The lateral wall 15 may be axisymmetric, but this condition is not necessary.

The lateral wall 15, together with the base wall 14, defines a containment space 16 inside which most of the substance intended to be contained in the container 10 can be received.

The second component 2 has a second joining portion 17 suitable for being joined to the first joining portion 7 of the first component 1 in order to create a joint 19 by means of which the first component 1 is attached to the second component 2.

The second joining portion 17 may comprise a further flange 18 suitable for being pressed against the flange 8 of the first component 1 in such a way that the flange 8 is fixed to the further flange 18.

In the example shown, the further flange 18 is substantially flat. However, this condition is not necessary and, in an alternative embodiment, the further flange 18 could have a geometry that is not flat. In general, in a cross-section taken in a plane containing the axis Z, the shape of the further flange 18 may match that of the flange 8. If seen in plan view, the further flange 18 may be shaped like an annulus, but even this condition is not necessary because the shape of the further flange 18 depends on the cross-section of the second component 2.

The second component 2 is a moulded component. For example, the second component 2 may be formed by means of a substantially dry forming process, which uses a cellulose-based starting material containing a quantity of water not greater than 20% by weight. The starting material may be in the form of powder. Alternatively, the starting material may be a fluffy element, for example a wad of fluff or a dose of airlaid.

It is also possible for the second component 2 to be produced by means of a wet forming process.

The second component 2 is a one-piece component.

In order to join the first component 1 to the second component 2, the first joining portion 7 is brought into contact with the second joining portion 17 and a pressing force is applied to render the flange 8 fixed relative to the further flange 18. At the same time, heat may be applied.

In order to make joining of the first component 1 and the second component 2 possible, at least one joining portion selected from either the first joining portion 7 or the second joining portion 17 may comprise fibres that are at least partially free.

The expression “fibres that are at least partially free” means that the fibres are not incorporated in a high density compacted structure, in which the fibres are arranged in a substantially fixed position. The fibres that are at least partially free are not rigidly constrained in a predetermined position by the adjacent fibres and, as a result of the application of a pressing force, they can change their position, interacting with the other component against which they are pressed, for example interacting with other fibres that are at least partially free belonging to the other component. In this way, a strong and lasting bond can be established between the first component 1 and the second component 2.

The fibres may be at least partially free, for example, because they are part of a relatively low density structure, the density intended to be increased during the pressing step, or as a consequence of a surface treatment which has produced fibres that are at least partially free on a portion of surface of the component involved, as will be described in more detail below.

The fibres that are partially free may have one free end, or both ends free, or a stretch of their central length free.

FIGS. 3 and 4 show an alternative embodiment of a first component 1a. The first component 1a comprises a first joining portion 7a in which the natural fibre-based material which forms the first component 1a has a density which is less than the density in the remaining parts of the first component 1a. In particular, the density in the first joining portion 7a is less than the density in the neck 3. If the intermediate portion 9 is present, the latter has a density which is greater than the density of the first joining portion 7a.

For example, the density in the first joining portion 7a may be half of the density in the remaining portions of the first component 1a, or even less.

The first component 1a is a moulded component, formed in a similar way to what was already described relative to the first component 1. When the first component 1a is formed, different moulding pressures are applied to the natural fibre-based material intended to form the first component 1a, depending on the desired density to be obtained in different portions of the first component 1a. In particular, in the first joining portion 7a, a moulding pressure is applied to the natural fibre-based material which is less than the moulding pressure applied in the neck 3 and in the intermediate portion 9, if present. The moulding pressure applied on the first joining portion 7a may even be zero, which means that the first joining portion 7a is not compacted relative to the starting natural fibre-based material.

Therefore, the first component 1a has a pre-moulded body, which in this case is defined by the neck 3 and by the intermediate portion 9, if present. The first joining portion 7a which surrounds the pre-moulded body is also present.

The density in the neck 3 and in the intermediate portion 9, if present, is equal to the density that the first component 1a will have in the finished container 10. In fact, the density of the neck 3 and of the intermediate portion 9, if present, is not changed when the first component 1a is joined to the second component 2.

The density of the first joining portion 7a is in contrast increased during a pressing step in which the first component 1a is joined to the second component 2. In the pressing step, the first joining portion 7a is pressed against the second joining portion 17 of the second component 2, until the density of the first joining portion 7a is brought to a value comparable to the density of the remaining portions of the first component 1a. For example, after the pressing step, the density of the first joining portion 7a may differ from the density of the remaining portions of the first component 1a by less than 10%.

The first joining portion 7a is delimited by an anchoring surface 22, suitable for being arranged in contact with a further anchoring surface 23 (shown in FIG. 2) which delimits the second joining portion 17 and to be stably joined to the latter in order to create the joint 19.

Given the low initial density of the first joining portion 7a, before the pressing step, on the anchoring surface 23 fibres are present that are at least partially free, which comprise at least partially free natural fibres. Thanks to the fibres that are at least partially free, which can easily bind to the fibres of the second component 2, the first joining portion 7a can be joined to the second joining portion 17 to form a joint 19 having good mechanical properties.

During the pressing step, the first joining portion 7a is shaped in contact with the second component 2, so as to obtain the first flange 8. In this way, the shape of the first joining portion 7a is changed, adapting it to the shape of the second joining portion 17 of the second component 2. Forming the first joining portion 7a in contact with the second joining portion 17, improves the join between the first component 1a and the second component 2, increasing the strength of the joint 19.

The pressing step during which the first component 1a is joined to the second component 2 is included in an overmoulding process by means of which the first component 1a is rendered fixed to the second component 2. The overmoulding process does not affect the entire first component 1a, only the first joining portion 7a.

The first joining portion 7a extends continuously around the axis Z, for example in the shape of an annulus. In this way, it is possible to create a joint 19 which does not have discontinuities around the axis Z.

In one embodiment not shown, the second joining portion 17 of the second component 2 may be similar to the first joining portion 7a of the first component 1a, that is to say, it may have a density which is less than the density in the remaining portions of the second component 2, before the second component 2 and the first component 1a are joined to each other. FIG. 5 schematically shows a further alternative embodiment of a first component 1b.

The first component 1b comprises a first joining portion 7b, which in the example shown is in the shape of a flange 8, delimited by an anchoring surface 22b which is intended to make contact with the second component 2.

On the anchoring surface 22b, a scratching or scraping surface treatment was carried out, which allows the fibres arranged near the anchoring surface 22b to be at least partially freed. The fibres arranged near the anchoring surface 22b, which were initially compacted in a high density structure, are partially detached from the underlying structure so as to be able to more easily interact with the fibres of the second component 2.

That is shown in a very schematic way in the enlargement of FIG. 5, which shows some fibres that are at least partially free F which extend from a compact substrate SC of the first joining portion 17.

The scratching or scraping surface treatment may for example be carried out by rubbing the anchoring surface 22b with sandpaper.

The fibres which were detached from the compact substrate SC of the first joining portion 7b can easily be bound to the second joining portion 17 of the second component 2, during the pressing step in which the two joining portions are brought into contact with each other.

In one embodiment not shown, the second joining portion 17 of the second component 2 may be similar to the first joining portion 7b of the first component 1b, that is to say, it may have fibres that are at least partially free on the anchoring surface as a results of a scratching or scraping surface treatment.

It is also possible to couple, by means of a pressing step, a component (selected from either the first component or the second component) having a joining portion in which fibres are present that are at least partially free, because the density is lower than in the remaining portions of that component, with another component (selected from either the second component or the first component) having a joining portion on whose anchoring surface fibres are present that are at least partially free as a result of a scratching or scraping surface treatment.

In an alternative embodiment, to which FIGS. 7 and 8 relate, a method for forming a container from a sheet material is provided. In this embodiment, there may be a first component 100 suitable for being joined to a second component 200 which comprises a sheet material 20.

The first component 100, shown in detail in FIG. 6, is a container dispensing part and is similar to the first component described with reference to FIGS. 1 to 5. Everything previously described with reference to the first component shown in FIGS. 1 to 5 shall be understood to also apply to the first component 100, unless otherwise indicated.

The first component 100 has a joining portion 107 in the shape of a flange 108 having a radial dimension, or more generally a transversal dimension measured transversally to the axis Z, greater than the corresponding dimension of the flange 8 shown in FIGS. 1 to 5. The flange 108 is directly connected to the neck 3, which in this case is substantially the same as the neck 3 shown in FIGS. 1 to 5.

The flange 108 may be substantially flat. In other words, the flange 108 may be delimited by a substantially flat anchoring surface 122.

The intermediate portion, which was labelled with the reference number 9 in FIG. 2, is substantially absent in this case, since the flange 108 is directly joined to the neck 3.

The external diameter of the neck 3 and the external diameter of the flange 108 being equal, the anchoring surface 122 has an area greater than the area of the anchoring surface 22 shown in FIGS. 1 to 5.

That makes the first component 100 particularly suitable to be applied on the sheet material 20, which initially has a flat shape.

The sheet material 20 comprises at least one layer made with a natural fibre-based material, for example a cellulose layer, in particular of the so-called “paper board” or “carton board” type. The sheet material 20 may be a multi-layer material, in which case the natural fibre-based layer may be interposed between two layers of synthetic polymeric material, which give the laminated material barrier properties and make it heat-sealable. There may also be a layer made of aluminium or another polymer or another fibre-based material, for example micro or nano cellulose, if the features of a barrier to gas, vapours and aromas are necessary.

The multi-layer structure of the sheet material 16, if present, may be obtained by lamination, or by other technologies. Alternatively, the sheet material 20 may have a single-layer structure.

The sheet material 20 may be unwound from a reel, or in the form of a flat sheet. In the latter case, the sheet material 20 may optionally comprise a pre-cut sheet with dimensions such that it can form a single container.

The sheet material 20 is intended to be folded, welded and if necessary cut, in such a way as to form a container, for example a prismatic container, which can be opened or closed by acting on a cap removably applied on the neck 3. While the sheet material 20 is folded, it is also possible to fill the container with the desired substance.

The container formed from the sheet material 20 may be an aseptic container.

On the sheet material 20 there may be a plurality of holes 21, which are shown in FIG. 8, for example aligned along a longitudinal direction. A first component 100 is intended to be positioned at each hole 21, in such a way that the substance present in the container can be dispensed through the hole 21 and the dispensing passage 4 surrounded by the neck 3.

The first component 100 can be joined to the sheet material 20 during a pressing step in which the joining portion 107, defined by the flange 108, is pressed against the sheet material 20, if necessary with the application of heat.

In order to promote joining of the first component 100 and the sheet material 20, at least one of these two components may have fibres that are at least partially free on its surface which makes contact with the other component. For example, the joining portion 107 of the first component 100 could have a lower density than the remaining portions of the first component 100, in particular the neck 3. That is to say, the first component 100 could have a structure of the type shown in FIG. 4, in which the neck 3 already has its definitive density and shape, whilst the flange 108 has a relatively low density and is compacted in contact with the sheet material 20 so as to be joined to the latter. In that way, the joining portion 107 is overmoulded in contact with the sheet material 20, by pressing the flange 108 and increasing its density.

In an alternative embodiment, on an anchoring surface of it, which delimits the joining portion 107 on the opposite side to the neck 3, the flange 108 could have been subjected to a scratching or scraping treatment in order to render at least partially free several fibres in the zone of the interface with the sheet material 20. In this way, when the flange 108 is pressed against the sheet material 20, the fibres that are at least partially free more easily join to the sheet material 20.

It is also possible, in addition or alternatively to the above, to provide a scraping or scratching treatment on the sheet material 20, in particular on a surface of the sheet material 20 in contact with which the first component 100 is positioned, that is to say, on the upper surface of the sheet material 20, in the example in FIG. 8. The scraping or scratching treatment is carried out around the hole 21. Thanks to this treatment, the surface layers of the sheet material 20 are locally removed, for example the layers of synthetic polymeric material or of aluminium. This makes accessible the fibres of the underlying paper layer, which can more easily bind to the fibres of the first component 100, in particular to the natural fibres of the latter, with which they are chemically related. If necessary, it is also possible to apply an adhesive substance which improves joining of the two components, penetrating amongst the cellulose fibres of the first component 100 and of the paper layer of the sheet material 20.

FIGS. 9 to 12 show the steps of a method in which a first component 101 is moulded in contact with a second component 200, which in this example comprises a sheet material 20 similar to that described with reference to FIGS. 7 and 8.

The first component 101 is initially structured as a dose 24 of natural fibre-based material, in particular cellulose-based, if necessary containing small quantities of synthetic polymeric fibres or other additives. The dose 24 may be a fluffy element, for example a wad of fluff or airlaid.

The dose 24 may have a density of between 0.05 and 0.5g/cm3 .

The dose 24 may have the shape of a disk of cellulose-based material, in which case the dose 24 has a substantially circular shape in plan view. Alternatively, the dose 24 may have a polygonal shape in plan view, for example quadrangular, or other types of shape, depending on the object to be obtained. The dose 24 has a thickness which is less than its linear dimensions in plan view.

The dose 24 may have a geometry which is substantially flat, or not flat, for example concave or provided with localised compression zones.

The dose 24 may be obtained by cutting a cellulose-based material, for example airlaid, initially in the form of a sheet unwound from a reel.

The sheet material 20, which can be unwound from a reel, comprises a plurality of holes 21 as described with reference to FIGS. 7 and 8.

The dose 24 is subjected to a pressing step in contact with the sheet material 20 to obtain a container dispending part 25, shown in FIG. 12, moulded directly on the sheet material 20, in particular near a corresponding hole 21.

Once formed, the container dispending part 25 is similar to the container dispensing part described with reference to FIGS. 6 to 8.

In order to press the dose 24 it is possible to use a mould comprising a male mould part 26 and a female mould part 27, arranged in a position facing each other.

The male mould part 26 comprises a punch 28 for shaping the container dispending part 25 from the inside. The male mould part 26 further comprises a tubular element 29 which surrounds the punch 28. The female mould part 27 comprises a base 30, schematically shown in FIG. 11, and a plurality of sectors 31 for shaping the neck of the container dispending part 25 from the outside. The sectors 31 are movable between a start of forming configuration C1, shown in FIG. 9, and an end of forming configuration C2, shown in FIG. 11. In order to pass from the start of forming configuration C1 to the end of forming configuration C2, the sectors 31 move towards each other in such a way that the space defined between the sectors 31 is reduced.

The male mould part 26 and the female mould part 27 are aligned with each other along a moulding direction D.

An actuating device not shown moves at least one mould part selected from either the male part 26 or the female part 27 towards the other mould part selected from either the female part 27 or the male part 26, along the moulding direction D, or alternatively moves at least one of the above-mentioned mould parts away from the other mould part. In this way, it is possible to form the container dispending part 25 and then to extract the dispensing part 25 from the mould.

In an initial step, shown in FIG. 1, the male mould part 26 and the female mould part 27 are spaced apart from each other.

The sheet material 20 is delimited by an inner face 32, intended to be directed inwards towards the inside of the container which will be formed. The sheet material 20 is also delimited by an outer face 33, intended to be directed outwards from the container.

The female part 27 is arranged in a first half-space, delimited by the outer face 33 of the sheet material 20. The tubular element 29 engages with the inner face 32 of the sheet material 20. Therefore, the tubular element 29 is in the half-space opposite that in which the female mould part 27 is positioned, that half-space being defined by the sheet material 20.

The punch 28 is engaged inside the hole 21 and is positioned near the dose 24, although it has not yet started to interact with the latter. The dose 24 is resting on the female mould part 27, for example on the sectors 31, and is substantially undeformed.

The dose 24 is still spaced apart from the sheet material 20. More specifically, an anchoring surface 222 which delimits the dose 24 on the side directed towards the sheet material 20, is facing the outer face 33, without being in contact with the sheet material 20. The female mould part 27, which in this step supports the dose 24, is in fact positioned at a distance from the sheet material 20 which is greater than the thickness of the dose 24.

Then, as shown in FIG. 10, the punch 28 moves towards the female mould part 27 and starts to penetrate between the sectors 31, which are still arranged in the start of forming configuration C1. The dose 24 starts to be deformed by the punch 28 and takes on a concave shape, in a central region of it.

Then, as shown in FIG. 11, the sectors 31 shift into the end of forming configuration C2, so that the neck 3 of the container dispending part 25 is formed between the sectors 31 and the punch 28. The membrane 13, which closes the neck 3 at an end of it opposite to the sheet material 30 is also formed. For that reason, the base 30 and the punch 28 are brought to a distance from each other corresponding to the thickness of the membrane 13.

The base 30, which at least in this step is fixed relative to the sectors 31 along the moulding direction D, is moved towards the sheet material 20 until the dose 24 is brought into contact with the outer face 33. Simultaneously, the punch 28 moves back following the movement of the female part 27 along the moulding direction D.

Thanks to the movement of the female part 27 towards the sheet material 20, the dose 24 is pressed against the outer face 33, in such a way as to form the joining portion 107 which, in the example shown, comprises a flange 108 similar to the flange 108 shown in FIGS. 6 to 8. By forming the flange 108 in contact with the outer face 33, the flange 108 is stably anchored to the sheet material 20, in particular thanks to the interaction between the fibres which come out on the anchoring surface 222 and which, thanks to the low density structure of the dose 24, are still at least partially free.

The container dispensing part 25 is formed in this way and is simultaneously rendered fixed to the sheet material 20.

Therefore, in this embodiment, the first component 101 has a shape and a density which vary during the forming. Initially the first component 101 is defined by the dose 24. After the moulding or pressing of the dose 24 in contact with the sheet material 20, the first component 101 is defined by the container dispensing part 25.

Joining of the first component 101 and the sheet material 20 is improved if the sheet material 20 further comprises, on a further anchoring surface 223 intended to be joined to the flange 108, some fibres that are at least partially free. The further anchoring surface 223 surrounds the hole 21 and is defined on the outer face 33 of the sheet material 20. On the further anchoring surface 23, a scratching or scraping treatment can be carried out to locally remove any layers arranged on the outside of the paper layer and to at least partially detach some fibres of the paper layer from the central part of that layer.

After the container dispensing part 25 has been formed in contact with the sheet material 20, the female mould part 27 and the male mould part 26 are moved away from the sheet material 20. The sectors 31 are returned to the start of forming configuration C1, so that the sheet material 20, together with the container dispensing part 25 formed on it, can be disengaged and moved away from the mould, for example by moving the sheet material 20 along an advancement direction F1.

In the example shown in FIGS. 9 to 12, the dose 24 starts to be deformed while it is spaced apart from the sheet material 20. That is to say, the dose 24 is brought into contact with the sheet material 20 after deformation of the dose 24 has already started.

In an alternative embodiment, shown in FIGS. 13 to 17, the dose 24 is brought into contact with the sheet material 20 while it is still in an undeformed configuration, that is to say, before the dose 24 starts to be deformed by the female part 27 and/or by the male part 26.

As shown in FIG. 13, the dose 24, which in this step defines the first component 101, is initially in an undeformed configuration and is spaced apart from the sheet material 20. The dose 24 is facing the outer face 33 of the sheet material 20. More specifically, the dose 24 is supported by the female mould part 27, in particular resting on the sectors 31, which are in the start of forming configuration C1. The punch 28 does not project from the tubular element 29. The latter is in contact with the inner face 32 of the sheet material 20.

Then, as shown in FIG. 14, the female part 27 is moved towards the sheet material 20, thereby bringing the dose 24 into contact with the outer face 33, in particular at the anchoring surface 222 of the dose 24. The punch 28 can also be moved towards the dose 24 to make contact with a central region of the latter, although without starting to deform the dose 24. As shown in FIG. 15, the female part 27 continues to be moved towards the sheet material 20 in order to press the joining portion 107 of the dose 24 into contact with the outer face 33. In this way, the flange 108 starts to be formed, which renders the first component 101 fixed to the sheet material 20. The punch 28 projects from the tubular element 29 deforming the central region of the dose 24, which takes on a concave shape.

Then, the sectors 31 are brought into the end of forming configuration C2, as shown in FIG. 16. The punch 28 and the base 31 are also positioned at a distance from each other equal to the thickness of the membrane 13. In this way it is possible to form the neck 3, closed by the membrane 108. The container dispensing part 25 is now completely formed and is stably fixed to the outer face 33 of the sheet material 20, as shown in FIG. 17. Stable joining of the container dispensing part 25 and the sheet material 20 is facilitated by the fibres that are at least partially free which were present on the anchoring surface 222 before the dose 24 was pressed against the sheet material 20. In this case too, a scraping or scratching surface treatment carried out around the hole 21 on the outer face 33 can at least partially free some fibres of the paper layer of the sheet material 20, which improves joining of the first component 101 and the second component 200.

It is now possible to open the mould to disengage the container dispensing part 25.

In both of the embodiments shown in FIGS. 9 to 12 and 13 to 17, the container dispensing part 25 is formed in contact with the outer face 33 of the sheet material 20.

In an alternative embodiment, shown in FIGS. 18 to 22, the dose 24 can be moulded in contact with the inner face 32 of the sheet material 20, to create a container dispensing part 25 anchored to the inner face 32.

The mould used in this embodiment is similar to that shown in FIGS. 9 to 17 and will not be described in detail again.

As shown in FIG. 18, the dose 24 is initially positioned in the half-space delimited by the inner face 32 of the sheet material 20. More specifically, the dose 24 is initially in a position interposed between the sheet material 20 and the male mould part 26. Both the punch 28 and the tubular element 29 are initially spaced apart from the dose 24.

The female mould part 27 is in the half-mould delimited by the outer face 33 of the sheet material 20, that is to say, in the half-space opposite that in which the dose 24 is located.

The female mould part 27 is initially in a position spaced apart from the sheet material 20.

The male mould part 26 and the female mould part 27 are now moved towards the sheet material 20. In particular, as shown in FIG. 19, the tubular element 29 and the punch 28 are brought into contact with the dose 24, which in turn makes contact with the inner face 32 of the sheet material 20. In contrast, the sectors 31 are brought into contact with the outer face 33 of the sheet material 20.

The punch 28 starts to deform the dose 24. In particular, the central region of the dose 24 takes on a concave shape, whilst the thickness of the anchoring portion 107 is reduced.

The sectors 31 are brought into the end of forming configuration C2, as shown in FIG. 21, in order to form the neck 3. The distance between the base 30 and the punch 28 is reduced until it is rendered equal to the thickness of the membrane 13, which is formed in this way in order to close the neck 3.

The tubular element 29 compresses a peripheral region of the dose 24, compacting the material of the dose in the joining portion 107 and forming the flange 108. In this way, the first component 101 is formed already in a fixed position relative to the sheet material 20, that is to say, rendering it fixed to the sheet material 20.

In this case, the flange 108 is arranged inside the container which will be obtained from the sheet material 20, whilst the neck 30 projects outside the container to removably engage with the cap.

In this embodiment too, before the dose 24 is pressed into contact with the sheet material 20, the fibres of the joining portion 107 of the dose 24 are at least partially free, due to the low density of the dose 24.

The sheet material 20 may have been previously subjected to a scratching or scraping surface treatment in order to obtain fibres that are partially free on its inner face 32, around the hole 21.

After the forming, the mould is opened, as shown in FIG. 22, to disengage the sheet material 20 bearing the container dispensing part 25 from the male mould part 26 and from the female mould part 27.

In the examples shown, the moulding direction D is vertical. This condition is not necessary, and in an embodiment not shown the moulding direction D may be horizontal, or arranged obliquely relative to the horizontal direction.

Moreover, it is also possible that the female mould part 27, rather than being arranged below the male mould part 26, is arranged below or alongside the latter, in a position facing the male mould part 26.

FIGS. 23 to 24 show an embodiment in which the container is a squeezable container 40, suitable for containing highly viscous fluid substances such as cosmetic products, food products, pharmaceutical products and the like.

The squeezable container 40 comprises a first component 110, shaped like a container dispensing part, joined to a second component 220, which comprises a container body. The second component 220 may in particular comprise a squeezable tube, having one closed end 34, for example closed by welding.

The first component 110 is made with a natural fibre-based material, for example cellulose, optionally of the type previously described. The second component 220 may also be made with a material which contains natural fibres. The second component 220 may have a laminated structure and comprise for example layers made of synthetic polymeric material and/or of aluminium to increase the weldability of the material and improve the barrier properties.

In the example shown, the first component 110 is geometrically similar to the first component 1 shown in FIGS. 1 to 5. However, the first component 110 may also have a shape different from that indicated in FIGS. 1 to 5.

The first component 110 is a moulded component, for example obtained by means of a substantially dry forming process, which uses a cellulose-based starting material containing a quantity of water not greater than 20% by weight. The starting material may be in the form of powder. Alternatively, the starting material may be a fluffy element, for example a wad of fluff or a dose of airlaid.

The first component 110 is a one-piece component.

The first component 110 and the second component 220 are formed separately and are joined to each other in a pressing step which creates a joint 119. In the joint 119, a joining portion 117 of the first component 110, for example shaped like a flange 118, is joined to a further joining portion 217 of the second component 220. The further joining portion 217 may comprise a further flange 218.

On an anchoring surface 322 which delimits the joining portion 117 of the first component 110 fibres may be present that are at least partially free. For that reason, the joining portion 117 may comprise material which is not compacted, that is to say, a natural fibre-based material having a density which is less than the density that the material of the joining portion 117 will have in the finished container 40.

Alternatively, the joining portion 117 of the first component 110, and/or the further joining portion 217 of the second component 220, may comprise natural fibres that are at least partially free due to a scratching and/or scraping surface treatment carried out before coupling the first component 110 to the second component 220.

FIGS. 26 and 27 show a closure 50 for a container. The closure 50 is obtained by joining a first component 51 and a second component 52, during a pressing step. The first component 51 is made with a natural fibre-based material, for example cellulose, of the type previously described. The second component 52 also contains natural fibres, in particular cellulose, and may be made with the same material that forms the first component 51.

The first component 51 comprises a lateral wall 53, which extends around an axis Z1, and a transversal wall 54, arranged transversally, in particular perpendicularly, to the axis Z1. During use, the lateral wall 53 is fixed to a container neck, for example by a threaded connection or by other coupling means. In the transversal wall 54 a dispensing opening 55 may be present for dispensing a substance contained in the container which the closure 50 is intended to close.

Therefore, the first component 51 is shaped like an attaching part for attaching the closure 50 to the neck of the container

The second component 52 is a closure body suitable for removably engaging with the first component 51 to close the dispensing opening 55. The second component 52 may comprise an end wall 56 which, when the closure 50 is arranged in a closed position, extends transversally, for example perpendicularly, to the axis Z1. The second component 52 further comprises a skirt 57 which projects from the end wall 56. In the closed position, the skirt 57 is coaxial with the lateral wall 53.

From the end wall 56 a protuberance 58 may extend, for example having a hollow cylindrical shape, suitable for engaging in the opening 55 to keep the closure 50 in the closed position, thanks to mechanical interference.

The skirt 57 may have a tab 59 suitable for being gripped by a user to shift the second component 52 from the closed position to an open position. The tab 59 may project from an edge of the skirt 57 which, in the closed position, is near the first component 51.

The closure 50 further comprises a hinge structure 60 at which the first component 51 is joined to the second component 52. The second component 52 may be brought into the open position, or alternatively into the closed position, by rotating it relative to the first component 51, around the hinge structure 60.

The hinge structure 60 may have the shape of a band that joins the first component 51 to the second component 52. The hinge structure 60 may be arranged in a position diametrically opposed to the tab 59.

The first component 51 and the second component 52 are each a moulded component, for example obtained by means of a substantially dry forming process, which uses a cellulose-based starting material containing a quantity of water not greater than 20% by weight. The starting material may be in the form of powder. Alternatively, the starting material may be a fluffy element, for example a wad of fluff or a dose of airlaid.

The first component 51 and the second component 52 are each a one-piece component.

The first component 51 and the second component 52 are formed separately and are joined to each other in a pressing step which creates a joint 69. In the joint 69, a joining portion 67 of the first component 51 is joined to a further joining portion 77 of the second component 52 by pressing.

The joining portion 67 comprises an appendage which projects outwards from a region of the lateral wall 53. The joining portion 67 e delimited by an anchoring surface 62 which may be substantially flat. The anchoring surface 62 may lie in a plane parallel to a further plane defined by the transversal wall 54.

The further joining portion 77 comprises a further appendage which projects outwards from a region of the skirt 57. The further joining portion 77 is delimited by a further anchoring surface 63 which may be substantially flat and in particular may lie in a plane substantially parallel to that identified by the end wall 56.

The first component 51, before being joined to the second component 52, does not have a constant density. In fact, in the joining portion 67, the first component 51 has a density which is less than the density in the remaining portions of the first component 51, in particular less than the density of the lateral wall 53 and of the transversal wall 54. The joining portion 67 is a portion to be compacted of the first component 52. That means that, whilst the lateral wall 53 and the transversal wall 54 have reached their definitive shape and density during the moulding process at the end of which the first component 51 was formed, the material which forms the joining portion 67 is still to be compacted. On the anchoring surface 62 of the first component 51, before the latter is joined to the second component 52, there are therefore still fibres present that are partially free, that is to say, fibres that-due to the low density of the joining portion 67-are still not completely bound to the adjacent fibres and therefore have a significant freedom of movement.

Similarly, the second component 52, before being joined to the first component 51, in the end wall 56 and in the skirt 57 has a density which is greater than the density in the further joining portion 77. At the end of the moulding process by means of which the second component 52 was formed, the end wall 56 and the skirt 57 have reached their definitive shape and their final density. In contrast, the further joining portion 77 has a density which is less than the density that the hinge structure 60 will have in the finished closure 50. The further joining portion 77 must therefore still be compacted. On the further anchoring surface 63 which delimits the further joining portion 77, there are therefore some fibres present that are at least partially free.

In order to obtain the closure 50, the first component 51 and the second component 52 are positioned in such a way that the joining portion 67 is in contact with the further joining portion 77. In particular, the anchoring surface 62 and the further anchoring surface 63 are arranged in contact with each other. On the joining portion 67 and on the further joining portion 77 a pressing force is applied, labelled P in FIG. 27. As a result of application of the pressing force P, the thickness of the joining portion 67 and of the further joining portion 77 is reduced. The density at the joining portion 67 and of the further joining portion 77 is increased until it reaches a final value, substantially equal to the density in the remaining portions of the first component 51 and of the second component 52. In this way, the hinge structure 60 is formed and, simultaneously, the joining portion 67 is joined to the further joining portion 77. This makes it possible to obtain the closure 50, in which the first component 51 is securely joined to the second component 52.

Therefore, the first component 51 has a pre-moulded body, which in this case is defined by the lateral wall 53 and by the transversal wall 54. The first component 51 further comprises the joining portion 67 adjacent to the pre-moulded body.

The second component 52 also has a pre-moulded body, which comprises the skirt 57 and the end wall 56. The second component 52 further comprises the further joining portion 77 adjacent to the pre-moulded body. The pre-moulded body of the first component 51 and of the second component 52 are subjected to moulding before the pressing step, during which the first component 51 and the second component 52 are joined to each other. The joining portion 76 and the further joining portion 77 are subjected to moulding at least during the pressing step.

In an alternative embodiment, only one of the components selected from either the first component 51 or the second component 52 may have a density lower than the final density in the joining portion 67 and/or in the further joining portion 77. In contrast, the entire volume of the other component may be compacted. In this case, on the component which is not compacted, it is possible to carry out a scratching or scraping surface treatment which renders accessible some free fibres in the joining portion 67 and/or in the further joining portion 77. It is also possible that the first component 51 and the second component 52 are formed with a substantially uniform density throughout their entire volume, but that joining of the first component 51 and the second component 52 is made possible by a scratching or scraping surface treatment in at least one of the two components, as a result of which on the corresponding anchoring surface fibres are present that are at least partially free.

To summarise, below is a list of a plurality of example embodiments of a method for forming an object by joining two components in a pressing step:
one component, initially in the form of a dose of airlaid, is moulded in contact with a further compact component (overmoulding of the dose directly on the compact component);
one component, having a joining portion with a density lower than the density in the remaining portions of the component, is joined to a further compact component by pressing of the joining portion, which in this way is compacted and shaped into its definitive shape (overmoulding of the joining portion in contact with the compact component);
one compact component, having a joining portion in which fibres are present that are at least partially free, as a consequence of a scratching or scraping surface treatment, is joined to a further compact component by pressing the joining portion in contact with the further compact component.

In all three of the above-mentioned embodiments, the further compact component may optionally have a further joining portion in which fibres are present that are at least partially free, as a result of a scratching or scraping surface treatment, or the further compact component may optionally have a further joining portion having a density lower than its remaining portions, which is compacted during the pressing step by means of which the two components are joined.

In conclusion, a method comprises the features defined in the following phrases.

Phrase 1: Method comprising the steps of:
providing a sheet material (20);
applying a container dispensing part (25) on the sheet material (20);
folding and welding the sheet material (20) to obtain a container, wherein the container dispensing part (25) is made with a natural fibre-based material, which comprises at least 80% cellulose by weight.

Phrase 2: Method according to phrase 1, wherein at least the container dispensing part (25) is at least partially formed by a moulding process in contact with the sheet material (20).

Phrase 3: Method according to phrase 2, wherein the container dispensing part (25) comprises a pre-moulded body and a flange (8) which surrounds the pre-moulded body, the flange (8) initially having a density which is less than the density of the pre-moulded body, and wherein the flange (8) moulded in contact with the sheet material (20) to increase its density and to join the container dispensing part (25) to the sheet material (20).

Phrase 4: Method according to phrase 1 or 2, wherein the container dispensing part (25) is produced in contact with the sheet material (20) by moulding a dose (24) of said cellulose-based material.

Phrase 5: Method according to phrase 4, wherein the sheet material (20) has an inner face (32) intended to delimit an inner space of the container, and an outer face (33) on the opposite side to the inner face (32), the dose (24) being arranged in a position facing the inner face (32) near a hole (21) in the sheet material (20), wherein during moulding the dose (24) is compacted and shaped to form the container dispensing part (25), a neck of the container dispensing part (25) projecting from the outer face (33) through the hole (21).

Phrase 6: Method according to claim 4, wherein the sheet material (20) has an inner face (32) intended to delimit an inner space of the container, and an outer face (33) on the opposite side to the inner face (32), the dose (24) being arranged in a position facing the outer face (33) to form the container dispensing part (25) adhering to the outer face (33), wherein the dose (24) is brought into contact with the outer face (33) before being shaped.

Phrase 7: Method according to phrase 4, wherein the sheet material (20) has an inner face (32) intended to delimit an inner space of the container, and an outer face (33) on the opposite side to the inner face (32), the dose (24) being arranged in a position facing the outer face (33) to form the container dispensing part (25) adhering to the outer face (33), wherein the dose (24) starts being shaped before it is brought into contact with the outer face (33).

Phrase 8: Method according to any of phrases 1 to 7, wherein the sheet material (20) and/or the container dispensing part (25) are subjected to a scratching or scraping surface treatment in a zone in which they are intended to join to each other.

1. A method for forming an object by joining a first component and a second component which are made with respective materials both containing fibres which include natural fibres, wherein at least one component selected from either the first component or the second component is subjected to moulding, and wherein the first component and the second component are joined during a pressing step in which a joining portion of the first component is pressed into contact with the second component, the joining portion being delimited by an anchoring surface intended to be joined to the second component, and wherein, before the pressing step, on the anchoring surface; fibres are present that are at least partially free, in order to promote joining of the first component and the second component.

2. The method according to claim 1, wherein at least the joining portion of the first component is subjected to moulding during the pressing step.

3. The method according to claim 1, wherein the first component comprises a pre-moulded body which is adjacent to the joining portion and is produced before the pressing step by a moulding process, and wherein the moulding process leaves the joining portion unaltered or compacts the joining portion; less than the pre-moulded body so that, before the pressing step, the joining portion has a density which is less than the density of the pre-moulded body.

4. The method according to claim 1, wherein the entire mass of the first component is subjected to moulding during the pressing step.

5. The method according to claim 1, wherein the first component comprises a dose of cellulose-based material which is subjected to moulding simultaneously with said pressing step, so that the first component is overmoulded on the second component

6. The method according to claim 1, wherein the fibres that are at least partially free are originated during a scratching or scraping surface treatment on the anchoring surface.

7. The method according to claim 6, wherein the scratching or scraping surface treatment is carried out on a pre-moulded component produced before the pressing step by said moulding process.

8. The method according to claim 1, wherein the first component comprises a container dispensing part which has a perimetric flange the joining portion being defined by the perimetric flange

9. The method according to claim 8, wherein said object a container obtained by joining the first component to the second component, the second component being shaped like a cup-shaped body.

10. The method according to claim 8, wherein said object squeezable container obtained by joining the first component to the second component, the second component being obtained from a tube closed at one end

11. The method according to claim 8, wherein said object is a container, the second component is a sheet material intended to be at least folded and welded in order to obtain the container.

12. The method according to claim 5, wherein the second component is a sheet material intended to be at least folded and welded to obtain a container, and wherein the dose is moulded in contact with the sheet material to obtain a container dispensing part joined to the sheet material

13. Method The method according to claim 12, wherein the sheet material has an inner face intended to delimit an inner space of the container, and an outer face on the opposite side to the inner face the dose being arranged in a position facing the inner face near a hole in the sheet material, wherein during moulding the dose is compacted and shaped to form the container dispensing part, a neck of the container dispensing part projecting from the outer face through the hole.

14. The method according to claim 12, wherein the sheet material has an inner face intended to delimit an inner space of the container, and an outer face on the opposite side to the inner face the dose being arranged in a position facing the outer face to form the container dispensing part adhering to the outer face wherein the dose is brought into contact with the outer face before being shaped.

15. The method according to claim 12, wherein the sheet material has an inner face intended to delimit an inner space of the container, and an outer face on the opposite side to the inner face the dose being arranged in a position facing the outer face to form the container dispensing part adhering to the outer face, wherein the dose starts being shaped before it is brought into contact with the outer face

16. The method according to claim 1, wherein said object is a closure for a container, the closure further comprising a hinge structure which connects the first component to the second component.

17. The method according to claim 16, wherein the joining portion of the first component comprises an appendage which projects laterally from a wall of the first component, the second component having a further joining portion which projects laterally from a further wall of the second component wherein the joining portion is joined to the further joining portion during the pressing step.

18. The method according to claim 17, wherein the joining portion has a density which is less than the density of the wall from which it projects further projects, the joining portion further being compacted during the pressing step, so as to increase their its density and to change its shape in order to obtain the hinge structure

19. The method according to claim 17, wherein the first component is an attaching part for attaching the closure to a neck of the container, the second component being a closure body removably engageable with the first component to open or close the container.

20. (canceled)

21. The method according to claim 17, wherein the further joining portion has a density which is less than the density of the further wall from which it projects, the further joining portion being compacted during the pressing step, so as to increase its density and to change its shape in order to obtain the hinge structure.
